(19) United States
(12) Patent Application Publication
(10) Pub. No.: US 2015/0011811 A1
(43) Pub. Date: Jan. 8, 2015

(54) BOTTOM PRODUCT COOLING IN A FLUIDIZED-BED GASIFICATION

(71) Applicant: THYSSENKRUPP UHDE GMBH, Dortmund (DE)

(72) Inventors: Domenico Pavone, Bochum (DE); Ralf Abraham, Bergkamen (DE); Dobrin Toporov, Dortmund (DE)

(73) Assignee: ThyssenKrupp Industrial Solutions AG, Essen (DE)

(21) Appl. No.: 14/378,481

(22) PCT Filed: Feb. 4, 2013
(86) PCT No.: PCT/EP2013/052143

§ 371 Date: Aug. 13, 2014

(30) Foreign Application Priority Data
Feb. 14, 2012 (DE) 10 2012 002 711.7

(51) Int. Cl. C10G 1/00; B01J 8/24

(52) U.S. Cl. CPC C10G 1/002; B01J 8/24
USPC 585/240; 422/139

(57) ABSTRACT

Disclosed is a system and method for cooling and relieving pressure of the bottom product produced by the fluidized-bed gasification of biomass, brown coal, or hard coal having a high ash content. With such a method and system, an economic solution for cooling and pressure expansion of the bottom product produced is to be ensured, which is achieved by the bottom product leaving the fluidized bed at a maximum of 1500° C. and a pressure of up 40 bar, being fed to an intermediate store, then being fed from the intermediate store to a pressure tank having a cooling system, and then being fed to a pressure release system.

The invention is directed towards a method for the cooling and pressure reduction of the bottom product which results during a fluidized-bed gasification of biomass, brown coal and bituminous coal with high ash content.

By the development of a high-temperature Winkler coal gasification method, which constitutes a further development of the Winkler fluidized-bed gasification originally conducted under ambient pressure, the requirement arose to use the method not only in combined-cycle power plants for efficient and inexpensive power generation, but also for iron direct reduction and for synthesis gas for chemical products, wherein the development was also continued for the gasification of biomass and bituminous coal with high ash content. In this case, very high ash melting temperatures in excess of 1500° C. occur so that these fuels can no longer be used in an entrained flow gasifier. Fluidized-bed gasification, which is conducted below the ash melting point, is well suited to the use of such fuels (e.g. as described in U.S. Pat. No. 4,790,251), but substantial amounts of bottom product result and have to be discharged from the gasifier and cooled, i.e. it is necessary to cool the bottom product which is under pressure and at high temperature, which is carried out by means of bottom-product screw coolers, for example.

In the case of the known method, the autothermal gasification reaction between the solid carbonaceous gasification substance and the gaseous gasification agents, being oxygen or air, steam and carbon dioxide, takes place in a fluidized bed at a maximum of 1200° C. and up to 30 bar. The gasification substance is fed to the gasifier in a volumetrically controlled manner via the metering cellular wheel sluice (speed control) and introduced into the gasifier via the feed screw. The H₂-rich and CO-rich raw gas leaves the gasifier at the top. At the same time, dust, which in addition to the ash of the gasification substance contains non-converted carbon (about 40%), is discharged together with the raw gas. This dust is separated out to about 95% in the recirculation cyclone and recycled into the fluidized bed of the gasifier via the recirculation line.

The raw gas, laden with fine dust, leaves the recirculation cyclone in the direction of the raw gas cooler. At the bottom of the gasifier, the almost carbon-free ash, which is referred to as bottom product, is discharged into the ash outlet by means of the bottom-product screw cooler. The bottom product enters the bottom-product screw cooler, and therefore the ash outlet, at a temperature of up to 900°, and is cooled by means of cooling water to 60° C., and discharged from the pressure chamber. In the case of low ash contents (max. 15%), the assembly is still able to be used, but when using fuels with ash contents of up to 50%, the assembly can technically no longer be viable. With an input of, for example, 160 t/h of coal, 80 t/h of ash is produced as a result.

In the case of coals with high ash content, a technique according to U.S. Pat. No. 5,522,160 cannot be realised either on account of the high mass flow.

If the known type of cooling with screw coolers and separators to be arranged in a cascade-like manner were to be used, then this would no longer be technically and economically practical.

The invention starts at this point, the object of which is to ensure an economical solution for the cooling and pressure reduction of the resulting bottom product.

By means of a method of the type referred to in the introduction, this object is achieved according to the invention by the bottom product, which leaves the fluidized bed at a maximum of 1500° C. and at a pressure of up to 40 bar, being fed to an intermediate store, then being fed from the intermediate store to a pressure vessel with a cooling system, and then being fed to a pressure reduction system.

Using the method according to the invention, it is possible to achieve, with a compact type of construction, a sufficient temperature reduction as well as a pressure reduction of the bottom product according to a corresponding method for further treatment steps or for disposal of the bottom product.

The pressure reduction and the cooling considered separately are known in principle. Thus, WO2010/123477 A1 features a continuous ash pressure reduction system, and U.S.2011/0193018 A1 features a cooling system under ambient pressure.

Embodiments of the method according to the invention are to be gathered from the dependent claims. In this case, it can be provided that the system transitions from the gasifier to the intermediate store, from the intermediate store to the cooling system and from the cooling system to the pressure reduction system are provided by cooled screws, cooled cellular wheels or combinations of the two.

In a further embodiment, it can be provided that the bottom product cooling system is provided by a fluidized bed enclosed by a pressure vessel and heat exchangers located in the pressure vessel and/or by a fluidized bed/heat exchanger combination.

The type of heat exchanger in the fluidized bed of the pressure vessel can in this case be of very different design according to the invention, especially depending on the type of bottom product. Thus, a tube-type or plate-type heat exchanger can be provided, and the transporting of the bottom product past the heat exchanger surfaces can be carried out by means of gravitational force as well as in a staged fluidized bed, as the invention also provides.

In a further embodiment, it can be provided that the cooling gas which creates the fluidized bed in the pressure vessel is circulated, via dust-separating cyclones, via an external heat exchanger, wherein the pressure reduction is expediently carried out by means of an as-known per se sluice system which is also provided according to the invention in conjunction with the other system components.

For achieving the object, the invention also provides a plant which is especially distinguished by a pressurized fluidized-bed gasifier with a bottom product outlet, an intermediate store or buffer tank, a pressure vessel with cooling system for the bottom product and also a subsequent sluice system for pressure reduction.

Embodiments of the plant are gathered from the further dependent claims associated with the plant. In this case, provision can be made for a pressure vessel with a device for creating a fluidized bed for the bottom product with a heat exchanger and circulation of the gas which creates the fluidized bed.

Further features, individual details and advantages of the invention are provided on the basis of the following description and also with reference to the drawing. In the drawing

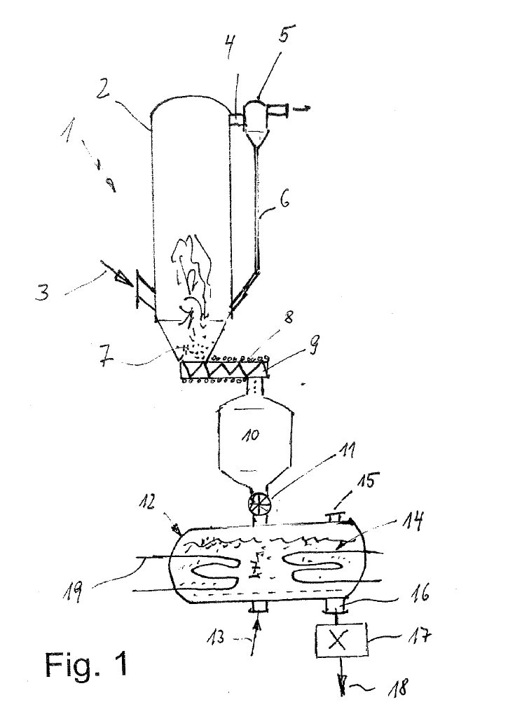

FIG. 1 shows a simple system schematic diagram of the plant according to the invention,

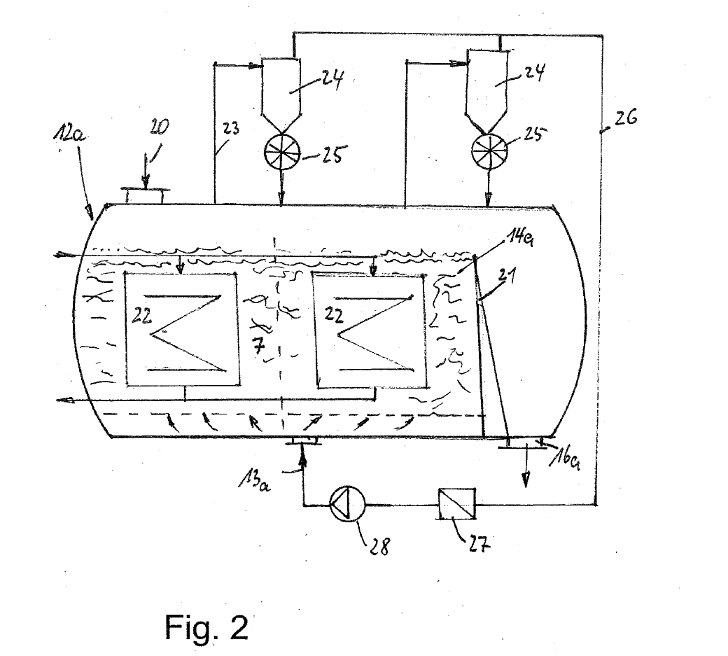

FIG. 2 shows an exemplary embodiment of a pressure vessel with cooling system in a fluidized bed,

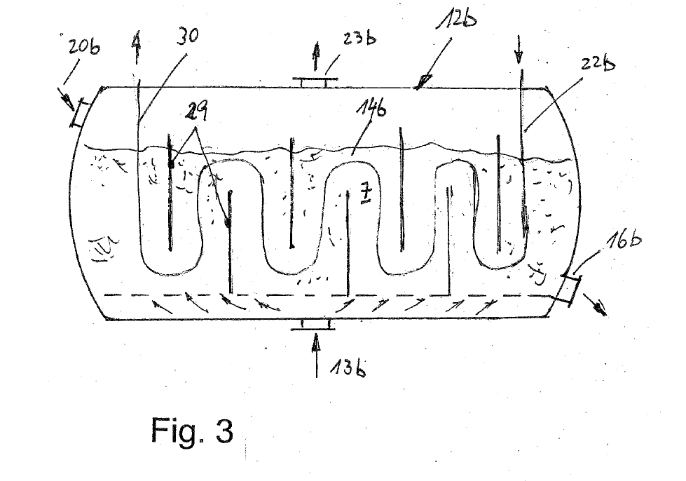

FIG. 3 shows a modified exemplary embodiment of the pressure vessel according to FIG. 2,

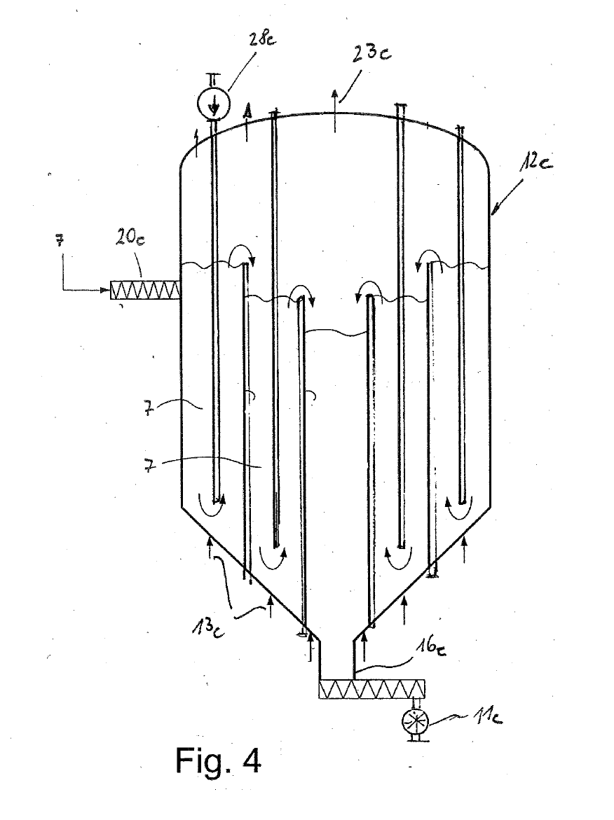

FIG. 4 shows a pressure vessel with a staged fluidized bed and

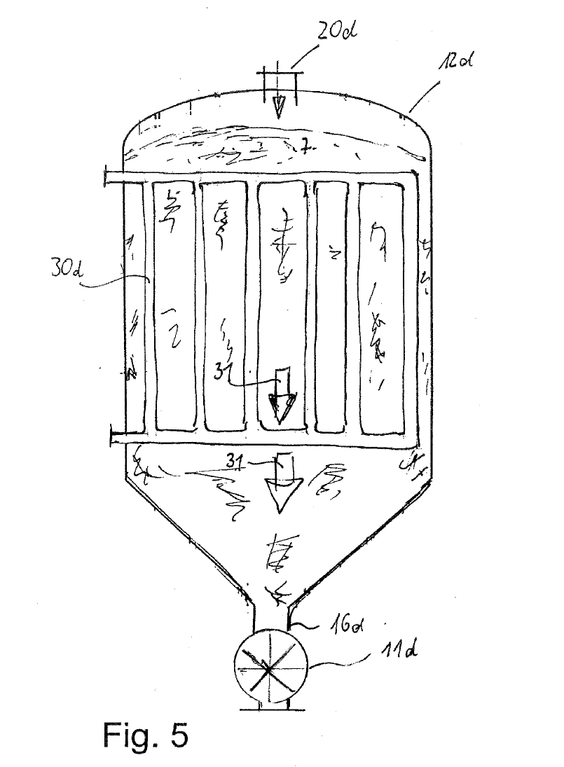

FIG. 5 shows a pressure vessel with cooling system and bottom product transporting by means of gravitational force.

The plant, generally designated by 1, for the cooling and pressure reduction of the bottom product which results during a fluidized-bed gasification of biomass is distinguished by a pressurised fluidized-bed gasifier 2, by the feed of the substance to be gasified, indicated by an arrow 3, and by the gas outlet, designated by 4, which leads into a dust-separating cyclone 5 from which a recirculation line 6 recycles the dust into the gasifier 2. The bottom product, identified by dots, bears the designation 7.

The bottom product 7 is transported via a screw 9, which is cooled by means of tube coils 8, into an intermediate store or buffer tank 10 and from there is fed, possibly in a timed manner, via a cellular wheel 11 to a pressure vessel 12.

In the pressure vessel 12, the bottom product is cooled in a fluidized bed, designated by 14, by feeding cold gas according to the arrow 13. The gas which creates the fluidized bed is discharged from the pressure vessel 12 at 15, and possibly cooled, and recirculated into the pressure vessel 12, as is shown in FIG. 2.

The cooled bottom product 7 leaves the pressure vessel 12 at 16 and is fed to a sluice system 17, in which the pressure is lowered, and is finally discharged at 18. Additionally shown in FIG. 1 is that a cooling device, indicated by cooling coils 19, is provided in the fluidized bed 14.

Shown in FIG. 2 is a pressure vessel 12a to which the bottom product is fed according to the arrow 20. The product 7 is transferred here, by means of a supplied gas 13a, into a fluidized bed which is located so that the bottom product can flow out in a cooled state via a weir, designated by 21, in order to leave the pressure vessel 12a via the connector 16a. Arranged in the fluidized bed 14a are tube-type heat exchangers 22, shown in the depicted example, which extract the heat from the bottom product 7 which is located in the fluidized bed.

The fluidized-bed gas is fed via lines 23 to cyclone dust separators 24, wherein the dust is recycled again via cellular wheels 25 into the pressure vessel 12a. The essentially dust-free, heated fluidized-bed gas is cooled via a recirculation line 26 and via a heat exchanger 27 and reintroduced into the pressure vessel by means of a pump 28.

Shown in FIG. 3 is a slightly modified exemplary embodiment, wherein the same elements, with regard to function, bear the same designations, suffixed by “b”

In this case, the bottom product is introduced into the pressure vessel 12b at 20b, wherein the fluidized bed 14b of the bottom product 7 is designed so that it effects a passage of the bottom product through the pressure vessel 12b, from left to right in the depicted example of FIG. 3, and in the process has to flow under and over weirs or corresponding baffles 29, wherein heat exchanger coils 30 in counterflow cool the bottom product.

Shown in FIG. 4 is again a modified exemplary embodiment, wherein in this case the same elements, with regard to function, bear the same designations, suffixed by “c”.

The pressure vessel 12c has in this case concentric baffles which serve as an obstacle for the bottom product 7, introduced at 20c, and under which and over which flow again has to pass, which is indicated by curved arrows. The gas which brings about the fluidized bed is introduced at 13c and discharged at 23c, wherein in the individual segments corresponding gas components at different temperature can also be discharged, which is indicated by means of small arrows at the top of the pressure vessel. A cooling medium, which is introduced by means of a pump 28c, can flow through the annular weirs or the annular baffles, which is shown only in FIG. 4.

Shown in FIG. 5 is a further modified exemplary embodiment, wherein in this case the same elements, with regard to function, bear the same designations, suffixed by “d”.

FIG. 5 shows a pressure vessel 12d to which is fed, via a filling connector 20d, the bottom product 7 which by means of gravitational force, represented by arrows 31, flows through the pressure vessel 12d in the direction of gravitational force without additional assistance and leaves the pressure vessel 12d via the outlet connector 16d.

Positioned in the pressure vessel 20d is a plate-type or tube-type heat exchanger 30d, through which flows a corresponding cooling medium.

Naturally, the invention is not limited to the depicted exemplary embodiments, but is to be additionally modified in many ways without the core of the invention being affected as a result. Thus, provision may be made for example inside a pressure vessel for different heat exchangers, for example different in constructional type, as tube-type or plate-type heat exchangers, or different in their operational data, which concerns the temperature of the respective heat exchanger medium, and the like.

### LIST OF DESIGNATIONS

1 Plant

2 Fluidized-bed gasifier

3, 13, 20, 31 Arrow

4 Gas outlet

5, 24 Cyclone dust separator

6, 26 Recirculation line

7 Bottom product

8 Tube coils

9 Screw

10 Buffer tank

11, 11c, 11d Cellular wheel

12, 12a-12d Pressure vessel

14 Fluidized bed

15 Outlet

16, 16a-16d Outlet

17 Sluice system

18 Outlet arrow

19 Cooling coil

21 Weir

22 Tube-type heat exchanger

23 Lines

25 Cellular wheels

27 Heat exchanger

28 Pump

29 Baffles

30 Heat exchanger coils

1.-8. (canceled)

9. A method for cooling and reducing the pressure of high bottom product produced by fluidized-bed gasification of biomass, brown coal, and bituminous coal having high ash content, comprising:
exposing biomass to a fluidized-bed gasification process;
generating high ash content bottom product from the biomass that has been exposed to the fluidized-bed gasification process;
conveying the bottom product, at a maximum temperature of 1,500° C. and a maximum pressure of 40 bar, away from a first fluidized-bed of the fluidized-bed gasification process and into an intermediate store;
conveying the bottom product from the intermediate store to a pressure vessel having a cooling system in communication therewith;
cooling, by the cooling system, the bottom product located within the pressure vessel;
conveying the bottom product from the pressure vessel to a pressure reduction system; and
reducing the pressure of the cooled bottom product by the pressure reduction system.

10. The method of claim 9, wherein each of the conveying steps are performed by at least one of cooled screws or cooled cellular wheels.

11. The method of claim 9, wherein the cooling system that is in communication with the pressure vessel includes at least one heat exchanger and a second fluidized-bed disposed within the pressure vessel.

12. The method of claim 9, wherein the cooling system includes at least one of a tube-type or plate-type heat exchanger disposed in the pressure vessel.

13. The method of claim 12, further comprising:
directing, by gravitational force, the bottom product contained within the pressure vessel to pass over heat exchanging surfaces of the heat exchanger.

14. The method of claim 11, further comprising:
circulating a cooling gas of the second fluidized-bed within the pressure vessel; from the pressure vessel through at least one dust-separating cyclone in communication with the pressurized vessel, through an external heat exchanger to cool the cooling gas, and back into the pressure vessel to cool the bottom product.

15. The method of claim 9, wherein said reducing the pressure of the cooled bottom product is performed by a sluice system.

16. A system for cooling and reducing pressure of bottom product generated from the fluidized-bed gasification of biomass, brown coal, or bituminous coal having high ash content, comprising:
a pressurized fluidized-bed degassifier configured to generate bottom product and having a bottom product outlet through which bottom product generated therein may exit therefrom;
a buffer tank in communication with said pressurized fluidized-bed degassifier and configured to store bottom product conveyed to thereto from said pressurized fluidized-bed degassifier;
a pressure vessel in communication with said buffer tank, the pressure vessel having a cooling system associated therewith and configured to cool bottom product contained therein; and
a sluice system in communication with said pressure vessel and configured to reduce the pressure of cooled bottom product conveyed thereto from said pressure vessel.

17. The system of claim 16, wherein said pressure vessel further includes a bottom product fluidized-bed disposed in an interior thereof and having at least one heat exchanger in communication with said bottom product fluidized-bed, and a pump configured to circulate cooling gas through said pressure vessel to create the fluidized-bed.
